(19) United States
(12) Patent Application Publication
(10) Pub. No.: US 2010/0171322 A1
(43) Pub. Date: Jul. 8, 2010

(54) Electromagnetic lock

(75) Inventor: Chih Chung Chang, Taipei Hsien (TW)

Correspondence Address: CHARLES E. BAXLEY, ESQUIRE, 90 JOHN STREET, SUITE 309, NEW YORK, NY, 10038, US

(73) Assignee: Gianni Industries Inc.

(21) Appl. No.: 12/319,358

(22) Filed: Jan. 6, 2009

(51) Int. Cl. E05C 19/16

(52) U.S. Cl. 292/251.5

(57) ABSTRACT

An electromagnetic lock includes a mounting plate for attaching to a supporting device and the mounting plate includes one or more protrusions each having a screw hole, a housing includes one or more passages aligned with the protrusions and the screw holes of the mounting plate for quickly anchoring and positioning the housing to the mounting plate, and a fastener is engaged through each passage of the housing and engaged with the screw hole of the mounting plate for easily and quickly securing the housing to the mounting plate and for preventing the housing from being held by the user for a long time.

### BACKGROUND OF THE INVENTION

1. Field of the Invention

The present invention relates to an electromagnetic lock, and more particularly to an electromagnetic door lock device including a mounting structure for allowing the electromagnetic door lock device to be easily and quickly mounted or attached or secured to the supporting structures or walls or members or devices.

2. Description of the Prior Art

Typical electromagnetic door lock devices comprise an electromagnetic device and an armature plate or the like to be mounted or attached or secured to the supporting structures or members or devices, such as the door panels, the door frames, the cabinets, the walls or the like, and arranged for allowing the electromagnetic device and the armature plate to be acted or actuated or operated with each other in order to selectively lock the door panels to the door frames, or to selectively release the door panels from the door frames.

For example, U.S. Pat. No. 4,826,223 to Geringer et al. discloses one of the typical electromagnetic door lock devices comprising an electromagnet, a bracket for holding the electromagnet in a door frame to force the opening therein, an electrical circuit for connecting the electromagnet to a power source, an armature magnetically attached to the electromagnet, and a connector for holding the armature on a door edge in the frame for adjustable movement towards the electromagnet and a lock component.

The electromagnet and the mounting brackets and the locking plates should first be secured together, and then attached or secured onto the supporting members, door panels, door frames, cabinets, walls or the like with fasteners. However, the electromagnet and the mounting brackets and the locking plates include a heavy weight that may not be easily held by the user while attaching or securing the electromagnet and the mounting brackets and the locking plates onto the supporting members, door panels, door frames, cabinets, walls or the like.

U.S. Pat. No. 4,915,431 to Bailey discloses another typical electromagnetic door lock comprising a self-adjusting switch assembly for door-movement alert, an armature adapted for floating attachment to a door by a plunger-bolt assembly fixed to the door, and an electromagnet adapted for fixed attachment to a door frame with fasteners.

However, the electromagnet also includes a heavy weight that may not be easily held by the user while attaching or securing the electromagnet onto the supporting members, door panels, door frames, cabinets, walls or the like.

U.S. Pat. No. 4,981,312 to Frolov, U.S. Pat. No. 5,133,581 to Coleman, U.S. Pat. No. 5,184,854 to Chen, U.S. Pat. No. 5,376,910 to Geringer et al., U.S. Pat. No. 6,135,515 to Roth et al., and U.S. Pat. No. 6,260,892 to Chang disclose the other typical electromagnetic door locks each also comprising an electromagnet adapted for fixed attachment to a door frame with fasteners, and an armature plate adapted for floating attachment to a door by a plunger-bolt assembly fixed to the door and for selectively locking the door panels to the door frames, or for selectively releasing the door panels from the door frames.

However, the electromagnet also includes a heavy weight that may not be easily held by the user while attaching or securing the electromagnet onto the supporting members, door panels, door frames, cabinets, walls or the like.

The present invention has arisen to mitigate and/or obviate the afore-described disadvantages of the conventional electromagnetic door lock devices.

### SUMMARY OF THE INVENTION

The primary objective of the present invention is to provide an electromagnetic lock including a mounting structure for allowing the electromagnetic door lock device to be easily and quickly mounted or attached or secured to the supporting structures or walls or members or devices.

In accordance with one aspect of the invention, there is provided an electromagnetic door lock device comprising a mounting plate including at least one aperture formed therein for receiving a first fastener and for mounting the mounting plate to a supporting device, and the mounting plate including at least one protrusion extended therefrom and including a screw hole formed in the protrusion, a housing including at least one passage formed therein and aligned with the protrusion and the screw hole of the mounting plate for quickly anchoring and positioning the housing to the mounting plate, and a second fastener engaged through the passage of the housing and engaged with the screw hole of the mounting plate for easily securing the housing to the mounting plate.

The housing includes a depression formed in the housing and communicating with the passage of the housing and having an outer diameter greater than that of the passage of the housing for receiving and engaging with the protrusion.

The housing includes a recess formed in the housing and communicating with the passage of the housing and the recess includes an outer diameter greater than that of the passage of the housing for receiving and engaging with a head of the second fastener.

The mounting plate includes at least one fence extended therefrom for forming and defining the aperture of the mounting plate.

The mounting plate includes at least one fence extended therefrom for forming and defining at least one recess in the mounting plate and for weight reducing purposes.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial perspective view illustrating an attachment or a mounting of an electromagnetic door lock device in accordance with the present invention to a supporting structure or wall or member or device;

FIG. 2 is a perspective view of the electromagnetic door lock device;

FIG. 3 is a partial exploded view of the electromagnetic door lock device;

FIG. 4 is a cross sectional view of the electromagnetic door lock device taken along lines 4-4 of FIG. 2;

FIG. 5 is a bottom perspective view illustrating a mounting plate of the electromagnetic door lock device;

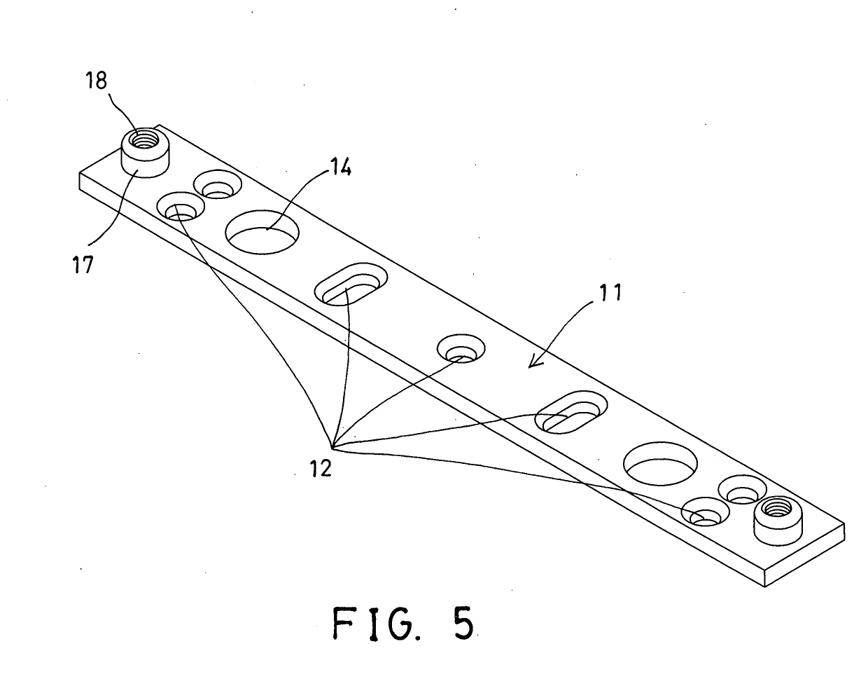

FIG. 6 is a cross sectional view of the mounting plate of the electromagnetic door lock device taken along lines 6-6 of FIG. 3; and

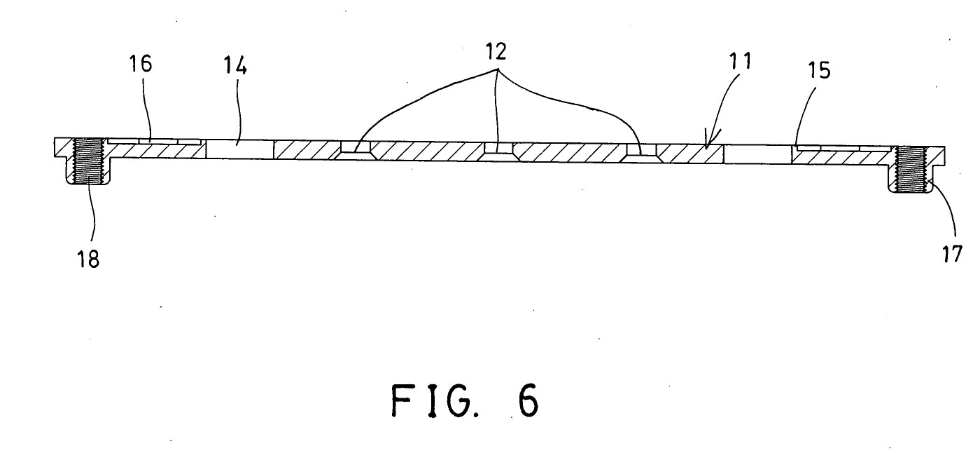

FIG. 7 is a partial perspective view similar to FIG. 1, illustrating the mounting or securing or assembling operation of the mounting plate of the electromagnetic door lock device onto the supporting members, door panels, door frames, cabinets, walls or the like.

### DETAILED DESCRIPTION OF THE PREFERRED EMBODIMENT

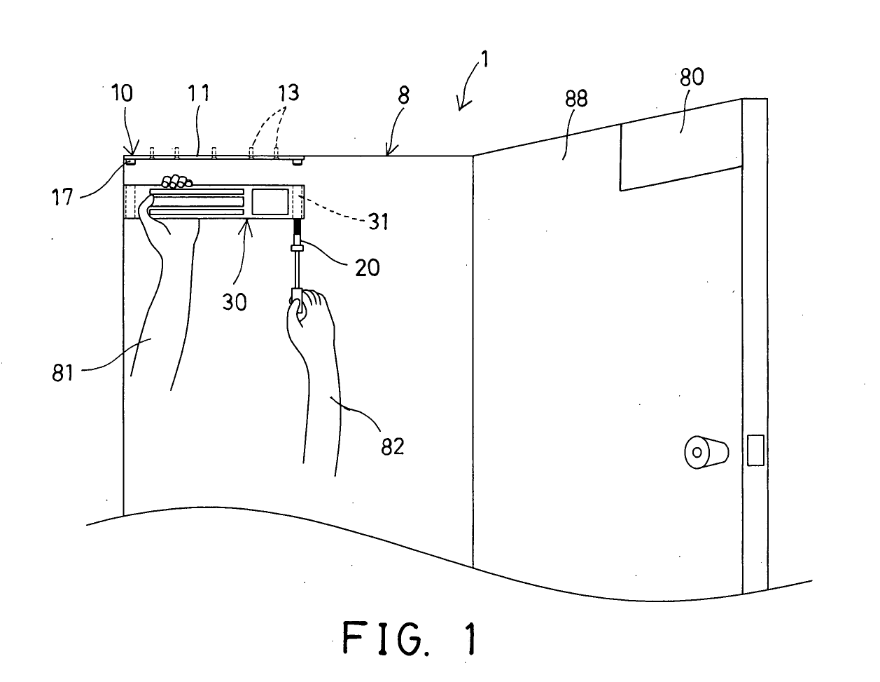

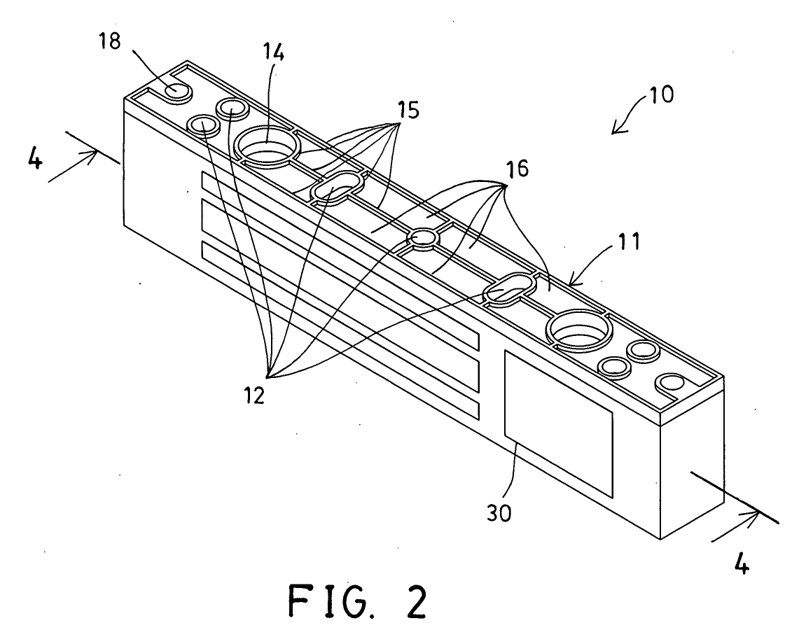

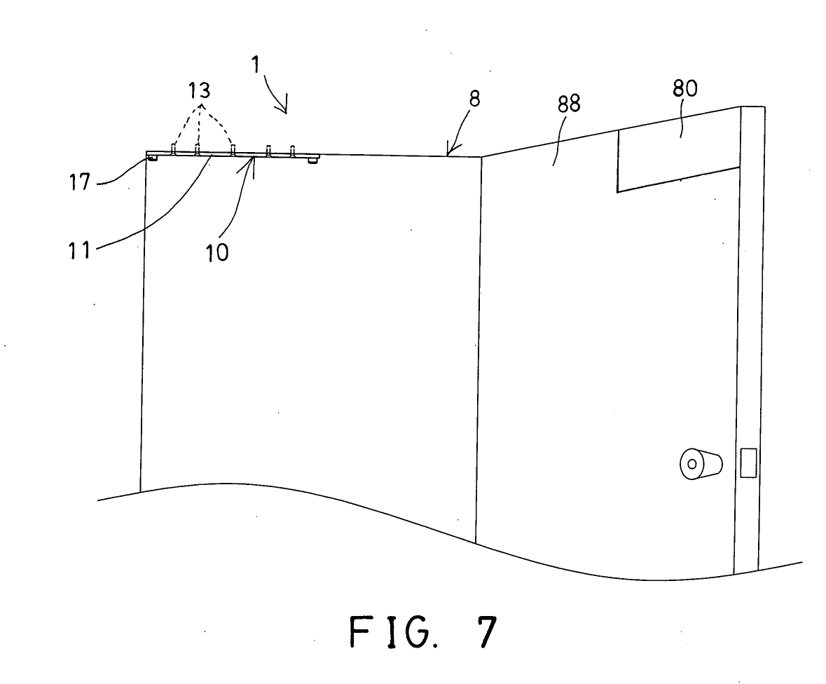

Referring to the drawings, and initially to FIGS. 1, 2 and 7, an electromagnetic lock 1 in accordance with the present invention comprises an electromagnetic device 10 provided for being mounted or attached or secured to a supporting structure or member or device 8, such as a door panel, a door frame 8, a cabinet, a wall member or the like, for acting or actuating or operating with an electromagnetic plate or armature plate 80 which is provided for being mounted or attached or secured to another supporting structure or member or device 88, such as a door frame, a cabinet, a wall member, a door panel 88, or the like, and arranged for allowing the electromagnetic device 10 and the armature plate 80 to be acted or actuated or operated with each other in order to selectively lock the door panel 88 to the door frame 8, or to selectively release the door panel 88 from the door frame 8.

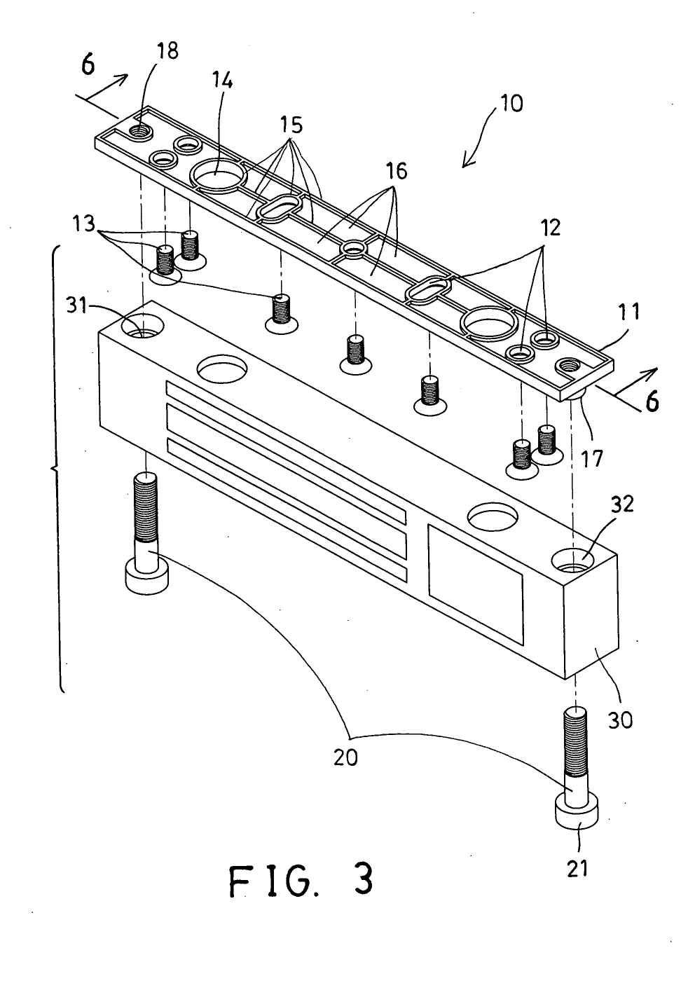

The electromagnetic device 10 includes a mounting plate 11 having one or more apertures 12 formed therein for receiving latches or fasteners 13 which may be used to attach or secure the mounting plate 11 to either of the supporting device 8, 88 (FIGS. 1, 3, 7), and having one or more openings 14 formed in the mounting plate 11 for receiving one or more electrical wires or cables (not shown) which may be required to be engaged through the supporting device 8, 88, and the mounting plate 11 includes one or more peripheral or reinforcing ribs or fences 15 extended upwardly therefrom for forming or defining one or more recesses 16 in the upper portion of the mounting plate 11 and for weight reducing purposes. The peripheral or reinforcing ribs or fences 15 may also be used to form or define the apertures 12 and/or the openings 14 of the mounting plate 11.

The mounting plate 11 further includes one or more (such as two) protrusions 17 extended downwardly therefrom, and a screw hole 18 formed in each of the protrusions 17 for receiving or engaging with a fastening means or device or fastener 20 which may be used to solidly secure a housing 30 to the mounting plate 11, in which the housing 30 is provided for receiving the typical electromagnetic members (not shown), such as the coils, the plungers, the solenoids or the like. Several examples of the typical electromagnetic members have been shown and disclosed in U.S. Pat. No. 4,981,312 to Frolov, U.S. Pat. No. 5,133,581 to Coleman, U.S. Pat. No. 5,184,854 to Chen, U.S. Pat. No. 5,376,910 to Geringer et al., U.S. Pat. No. 6,135,515 to Roth et al., and U.S. Pat. No. 6,260,892 to Chang which may be taken as the references for the present invention.

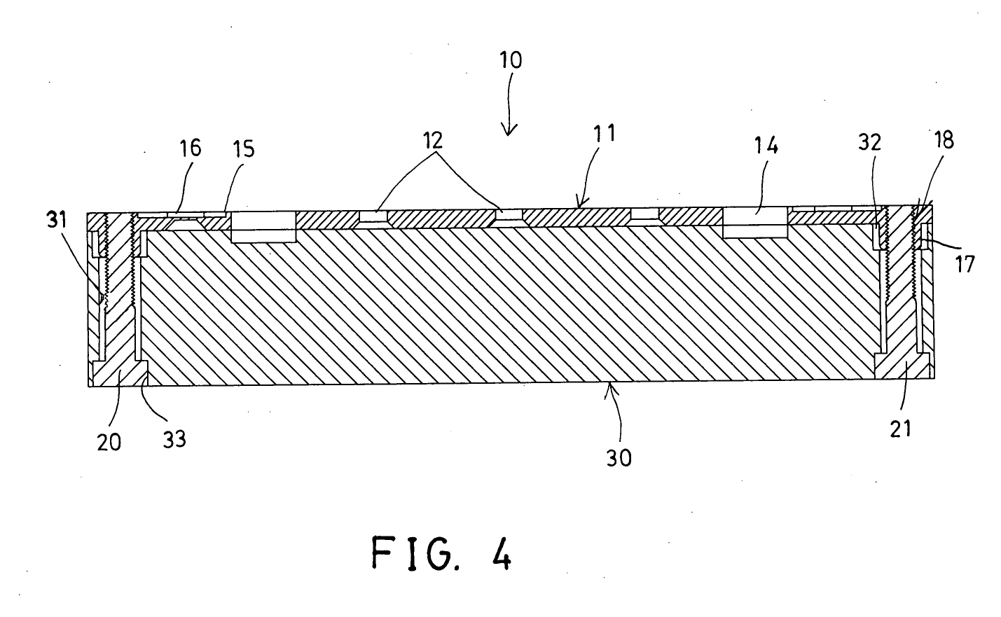

The housing 30 includes one or more (such as two) passages 31 formed therein and aligned with the protrusions 17 and the screw holes 18 of the mounting plate 11 for receiving or engaging with the protrusions 17 and the fasteners 20, and includes one or more (such as two) depressions 32 formed in the upper portion of the housing 30 and communicating with the passages 31 of the housing 30 respectively and having an outer diameter greater than that of the passages 31 of the housing 30 for receiving or engaging with the protrusions 17 respectively (FIG. 4), and includes one or more (such as two) recesses 33 formed in the lower portion of the housing 30 and also communicating with the passages 31 of the housing 30 respectively and having an outer diameter greater than that of the passages 31 of the housing 30 for receiving or engaging with the enlarged head 21 of the fasteners 20 respectively.

In operation or in assembling the mounting plate 11 and the housing 30 to either of the supporting device 8, 88, as shown in FIG. 1, the mounting plate 11 which includes a light weight may be easily held by the user and may be easily secured to the supporting device 8, 88 with the fasteners 13. The housing 30 may then be moved toward the mounting plate 11 to have the protrusions 17 engaged into the depressions 32 of the housing 30 respectively, and the fasteners 20 may then be engaged through the passages 31 of the housing 30 and engaged with the screw holes 18 of the mounting plate 11 for solidly and stably securing and assembling the mounting plate 11 and the housing 30 together, and for allowing the mounting plate 11 and the housing 30 to be easily and quickly and solidly mounted or attached or secured to the supporting device 8, 88.

It is to be noted that the mounting plate 11 may first be easily and solidly attached or secured to either of the supporting device 8, 88 with the latches or fasteners 13, and the housing 30 may then be quickly anchored and positioned to the mounting plate 11 by aligning and engaging the protrusions 17 of the mounting plate 11 into the depressions 32 of the housing 30 respectively, the fasteners 20 may then be quickly engaged through the passages 31 of the housing 30 and quickly engaged with the screw holes 18 of the mounting plate 11 for quickly securing and assembling the mounting plate 11 and the housing 30 together without holding the housing 30 for a long time.

Accordingly, the electromagnetic door lock device in accordance with the present invention includes a mounting structure for allowing the electromagnetic door lock device to be easily and quickly mounted or attached or secured to the supporting structures or members or devices.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. An electromagnetic lock comprising:
a mounting plate including at least one aperture formed therein for receiving a first fastener and for mounting said mounting plate to a supporting device, and said mounting plate including at least one protrusion extended therefrom and including a screw hole formed in said at least one protrusion,
a housing including at least one passage formed therein and aligned with said at least one protrusion and said screw hole of said mounting plate for quickly anchoring and positioning said housing to said mounting plate, and
a second fastener engaged through said at least one passage of said housing and engaged with said screw hole of said mounting plate for securing said housing to said mounting plate.

2. The electromagnetic lock as claimed in claim 1, wherein said housing includes a depression formed in said housing and communicating with said at least one passage of said housing and having an outer diameter greater than that of said at least one passage of said housing for receiving and engaging with said at least one protrusion.

3. The electromagnetic lock as claimed in claim 1, wherein said housing includes a recess formed in said housing and communicating with said at least one passage of said housing and having an outer diameter greater than that of said at least one passage of said housing for receiving and engaging with a head of said second fastener.

4. The electromagnetic lock as claimed in claim 1, wherein said mounting plate includes at least one fence extended therefrom for forming and defining said at least one aperture of said mounting plate.

5. The electromagnetic lock as claimed in claim 1, wherein said mounting plate includes at least one fence extended therefrom for forming and defining at least one recess in said mounting plate and for weight reducing purposes.
